(19) United States
(12) Patent Application Publication
(10) Pub. No.: US 2025/0370913 A1
(43) Pub. Date: Dec. 4, 2025

(54) APPARATUS AND METHOD FOR PROVIDING SERVICE FOR TESTING APPLICATION, SERVICE PROVIDING SYSTEM INCLUDING SAME, AND NON-VOLATILE RECORDING MEDIUM HAVING COMPUTER PROGRAM RECORDED THEREIN

(71) Applicant: SK Planet Co., Ltd., Seongnam-si (KR)

(72) Inventors: Hyeong Min JU, Hwaseong-si (KR); Chi Gon LEE, Yongin-si (KR); Jae Man PARK, Seoul (KR); Myung Kyo JUNG, Uiwang-si (KR)

(21) Appl. No.: 19/303,261

(22) Filed: Aug. 18, 2025

Related U.S. Application Data
(63) Continuation of application No. PCT/KR2024/005774, filed on Apr. 29, 2024.

(30) Foreign Application Priority Data
May 30, 2023 (KR) 10-2023-0069545

(51) Int. Cl. G06F 11/3668; G06F 3/14

(52) U.S. Cl. CPC G06F 11/3668; G06F 3/1454

(57) ABSTRACT

Disclosed are an apparatus and a method for providing a service for testing an application, a service providing system including the same, and a non-volatile recording medium having a computer program recorded therein, and more particularly, an apparatus and a method for providing a service for testing an application that, when creating a scenario for application testing, support creation of a test scenario that is universally applicable regardless of a screen size or a screen mode of different terminals by supporting creation based on components on a screen according to execution of an application, and a service providing system including the same, and a non-volatile recording medium having a computer program recorded therein.

### CROSS-REFERENCE TO RELATED APPLICATIONS

This is a bypass continuation of International PCT Application No. PCT/KR2024/005774, filed on Apr. 29, 2024, which claims priority to Republic of Korea Patent Application No. 10-2023-0069545, filed on May 3, 2023, which are incorporated by reference herein in their entirety.

### BACKGROUND OF THE INVENTION

### Field of the Invention

The present disclosure relates to an apparatus and a method for providing a service for testing an application, a service providing system including the same, and a non-volatile recording medium having a computer program recorded therein, and more particularly, to an apparatus and a method for providing a service for testing an application that, when creating a scenario for application testing, support creation of a test scenario that is universally applicable regardless of a screen size or a screen mode of different terminals by supporting creation based on components on a screen according to execution of an application, and a service providing system including the same, and a non-volatile recording medium having a computer program recorded therein.

### Description of the Related Art

Recently, an application test service for monitoring failure and quality according to application development and operation has been provided, and the application test service consists of test automation according to scenario setting, non-functional test, and data visualization and analysis according to result information collection analysis.

At this time, the test automation is for scenario-based execution and test result confirmation, and QA resource efficiency, the non-functional test is for aging test, E2E loading speed, current consumption measurement, measuring APP traffic, and the like, and the result information collection analysis is for analyzing success, failure rate, and response time for each device, OS, app version, or network, CPU, memory, battery consumption, network size, and the like.

In addition, the importance of application operation monitoring is increasing due to OS version, terminal screen configuration, terminal performance, variety of terminal characteristics, increase in application complexity, and increase in server communication necessity.

Typically, an existing application test service is performed on the basis of a local mobile terminal directly connected to a developer terminal, and an automation test scenario is recorded in such a scheme that information that a developer operates an actual screen is recorded based on screen coordinates of a mobile terminal displayed on the developer terminal, and the scenario is performed in a coordinate-based macro scheme to perform automation test.

However, such a scheme has a limitation in application failure/quality confirmation according to regional characteristics, and has a limitation in that it is difficult to cope with a case where application failure/quality verification continuously for 24 hours is required.

In addition, in such an existing application test service, a test scenario is created by performing a test control input based on coordinates of a screen in accordance with a screen size fixed to a specific mobile terminal, so that it is impossible to apply a test scenario created in accordance with a fixed screen size to another type of mobile terminal in which the screen size is changed, and it is also impossible to apply the scenario even when the screen is rotated by rotating the mobile terminal to change the screen size at the time of creating the test scenario, and there is a problem that the test scenario cannot be applied to a foldable terminal having a plurality of screen modes because a display state varies from screen to screen.

As a result, the existing application test service has a problem of creating a test scenario for each model having a different screen state, screen mode, and screen size, and in the case of creating an existing scenario by an operation recording scheme, there is a limitation in that it is difficult to record an annotation or a description of a unit operation of the scenario and it is difficult to grasp a setting state of the scenario at a glance.

On the other hand, even if a test system is configured so that the test scenario is edited and the test scenario is performed in a web scheme so that the developer can access the test system from anywhere while performing tests in various regions for communication status confirmation, etc., since the scenario is created and the test is performed in a scheme of recording a click on a position on the screen while looking at the screen of the mobile terminal in a scheme of emulating or streaming the screen of the mobile terminal, problems (scenario inapplicability due to screen size change, scenario inapplicability when the control target arrangement is changed, scenario management inconvenience) due to the creation and execution of the scenario in the existing local manner occur in the same scheme.

### SUMMARY OF THE INVENTION

The present disclosure has been made in an effort to support the creation of a scenario for application testing in a web scheme, and support a single scenario to be commonly used by terminals of various screen configurations, by identifying when a component is selected on a mobile screen that is streamed for creating a scenario, the component itself instead of the corresponding location, and creating a scenario based on the component, thereby increasing versatility for an applied mobile terminal, and provide information on a component in a screen designated by a user so that unit operation description information of a scenario may be automatically generated and edited, thereby increasing the convenience of creating a script for a test scenario, and support a test operation to be intuitively grasped by only checking the script, thereby increasing user convenience.

Further, the present disclosure has been made in an effort to support easily grasping an abnormality of a screen switching operation according to the presence or absence of a component (element) in a screen set in advance when a screen is switched according to a change of a test step in a process of performing an application test using a test scenario, to support enabling real-time check of a test state without screen omission or delay by recording automatic test content separately from streaming in a local mobile terminal and, if necessary, transmitting a recorded video file, to support facilitating determination of a failure or quality, and to support accurately grasping a test situation and facilitating analysis of a failure content through a recorded video.

According to an aspect of the present disclosure, there may be provided a system for providing a service for testing an application, which may include: a mobile agent unit configured in a mobile terminal, and configured to transmit a screen display image for a screen of the mobile terminal, obtain and provide screen configuration information used in an operating system of the mobile terminal for the screen display, and including coordinates for each operable component of the screen and component information, and perform a function according to the remote control information upon receiving remote control information for operating the mobile terminal; a terminal agent unit configured in a management terminal communicating with the mobile terminal to receive the screen display image and transmit the screen display image in a streaming scheme, receive and transmit the screen configuration information corresponding to the screen display image, and receive and transmit the remote control information to the mobile terminal; and a service providing apparatus configured to provide a web page for creating a test scenario of an application installed in the mobile terminal, provide the screen display image received from the terminal agent unit through the web page, generate the remote control information according to operation information on any one of one or more components included in the screen display image, transmit the remote control information to the terminal agent unit, extract the component information corresponding to the operation information from the screen configuration information, generate event information including the component information, and accumulate one or more event information generated until the test scenario creation is completed to generate test scenario information.

The present disclosure supports a mobile terminal to conveniently create a test scenario for testing an application on a web-based basis, thereby improving the case of creating an automated script-based test scenario, and also supports a test scenario to be configured based on the component itself rather than the coordinates of the component when operating the component for executing a function of an application installed in the mobile terminal to generate a test scenario that is universally applicable to all types of mobile terminals having different screen sizes or screen structures, thereby greatly increasing the efficiency of creating the test scenario.

### BRIEF DESCRIPTION OF THE DRAWINGS

FIG. 1 is a configuration diagram of a system for providing a service for testing an application according to an embodiment of the present disclosure.

FIGS. 2 to 4 are operational example diagrams of a method for providing a service for testing an application of the service providing system according to an embodiment of the present disclosure.

FIG. 5 is a configuration diagram of an apparatus for providing a service for testing an application according to an embodiment of the present disclosure.

FIGS. 6 and 7 are flowcharts of a method for providing a service for testing an application of the service providing apparatus according to an embodiment of the present disclosure.

FIGS. 8 to 12 are operational example diagrams of the service providing apparatus according to an embodiment of the present disclosure.

### DETAILED DESCRIPTION

Hereinafter, detailed embodiments of the present disclosure will be described with reference to drawings.

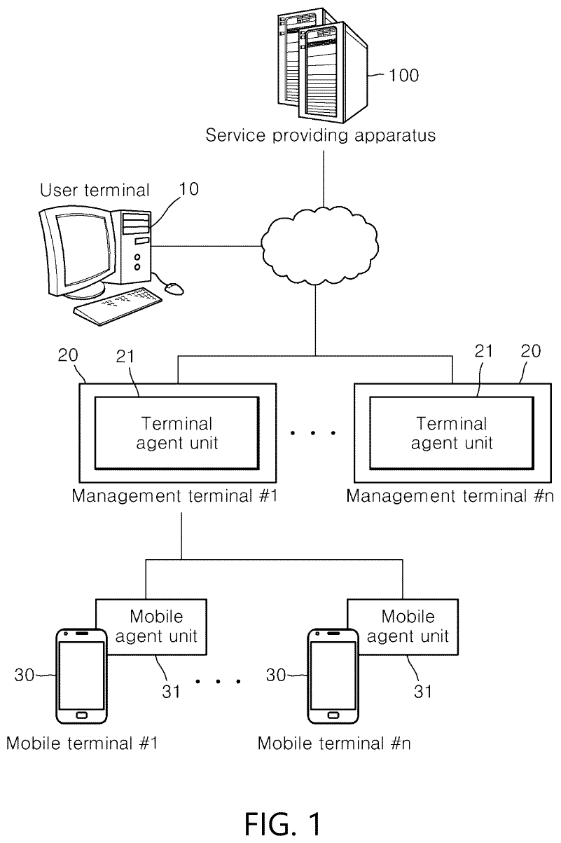

FIG. 1 is a configuration diagram of a system for providing a service for testing an application according to an embodiment of the present disclosure.

As illustrated in the figure, the system for providing a service for testing an application according to an embodiment of the present disclosure may be configured to include a management terminal 20, a mobile terminal 30 communicating with the management terminal 20, a service providing apparatus 100 communicating with the management terminal 20 via a communication network, and a user terminal 10 communicating with the service providing apparatus 100 via the communication network.

In this case, the management terminal 20 and the mobile terminal 30 may be configured locally, and the service providing apparatus 100 may be configured remotely from locations of the management terminal 20 or the mobile terminal 30.

Further, the service providing system for application testing may be implemented by more components than the components illustrated in FIG. 1, and the service providing system for application testing may also be implemented by fewer components.

Further, the communication network described in the present disclosure may include a wired/wireless communication network, and examples of the wireless communication network may include Digital Living Network Alliance (DLNA), Wireless Broadband (Wibro), World Interoperability for Microwave Access (Wimax), Global System for Mobile communication (GSM), Code Division Multi Access (CDMA), Code Division Multi Access 2000 (CDMA2000), Enhanced Voice-Data Optimized or Enhanced Voice-Data Only (EV-DO), Wideband CDMA (WCDMA), High Speed Downlink Packet Access (HSDPA), High Speed Uplink Packet Access (HSUPA), IEEE 802.16, Long Term Evolution (LTE), Long Term Evolution-Advanced (LTE-A), Wireless Mobile Broadband Service (WMBS), 5G mobile communication service, Bluetooth, Long Range (LoRa), Radio Frequency Identification (RFID), Infrared Data Association (IrDA), Ultra Wideband (UWB), ZigBee, Near Field Communication (NFC), Ultra Sound Communication (USC), Visible Light Communication (VLC), Wi-Fi, Wi-Fi Direct, and the like. In addition, the wired communication network may include wired local area network (LAN), wired wide area network (WAN), power line communication (PLC), USB communication, Ethernet, serial communication, optical/coaxial cables, etc.

In addition, the user terminal 10, the mobile terminal 30, or the management terminal 20 may include a smart phone, a portable terminal, a mobile terminal, a personal digital assistant (PDA), a personal computer, a notebook computer, a slate PC, a tablet PC, an ultrabook, and the like which have a communication function.

In addition, the service providing apparatus 100 may be configured as a service server.

In addition, the service providing system for application testing according to an embodiment of the present disclosure may include a mobile agent unit 31 configured in the mobile terminal 30 and a terminal agent unit 21 (or a management agent unit) configured in the management terminal 20.

In this case, each of the user terminal 10, the mobile terminal 30, and the management terminal 20 may include a terminal communication unit, a terminal storage unit, a terminal display unit, a terminal input unit, a terminal control unit, and the like.

In addition, the terminal communication unit may communicate with another device through the communication network, and may include an interface unit for wired communication with the other device.

As an example, the interface unit configured in each of the mobile terminal 30 and the management terminal 20 may include a universal serial bus (USB)-based communication interface, so that the mobile terminal 30 is connected to the management terminal 20 by wire through the interface unit to communicate with each other on a USB basis.

In addition, the terminal storage unit may store various kinds of information, and the terminal storage unit 130 may be configured in various forms such as a hard disk drive (HDD) and a solid state drive (SSD), and like.

In addition, the terminal control unit 30 performs an overall control function of the mobile terminal 30 or the management terminal 20, and the terminal control unit may include a RAM, a ROM, a CPU, a GPU, and a bus, and the RAM, the ROM, the CPU, the GPU, etc. may be connected to each other via the bus.

Further, the terminal communication unit and the terminal storage unit may also be configured to be included in the terminal control unit.

In addition, the terminal display unit may be configured to display various types of information, and the terminal input unit may receive a user input.

In addition, the terminal display unit and the terminal input unit may be configured as components constituting one touch screen.

In addition, the mobile agent unit 31 may be configured as a terminal control unit in a state of executing an agent program for the mobile terminal, which is data installed in the mobile terminal 30 and stored in the terminal storage unit of the mobile terminal 30.

In addition, the terminal agent unit 21 (or management agent unit) may be configured as a terminal control unit installed in the management terminal 20, and in a state of executing an agent program for the management terminal, which is data installed in the terminal storage unit of the management terminal 20.

Further, the user terminal 10 may be configured to include an editing agent unit that stores an editing agent program for creating a test scenario in the terminal storage unit by connecting to the service providing apparatus 100, and that is a terminal control unit configured in the user terminal 10 and in a state of executing the editing agent program and a configuration of the user terminal 10 described below may be performed by the editing agent unit.

According to the above-described configuration, the service providing system for application testing according to the present disclosure provides an interface for creating a test scenario for testing an application installed in the mobile terminal 30 from before execution of the application to a state in which execution of the application is completed to the user terminal 10 while communicating with the terminal agent unit 21 of the management terminal 20 that manages the mobile agent unit 31 in conjunction with the mobile agent unit 30 configured in the mobile terminal through a communication network with the service providing apparatus 100, and supports creation of the test scenario based on components included in a screen of the mobile terminal 30, so as to create a test scenario applicable to all types of mobile terminals 30 having different sizes and screen configurations, and supports convenient application testing based on such a test scenario, which will be described in detail below with reference to the drawings.

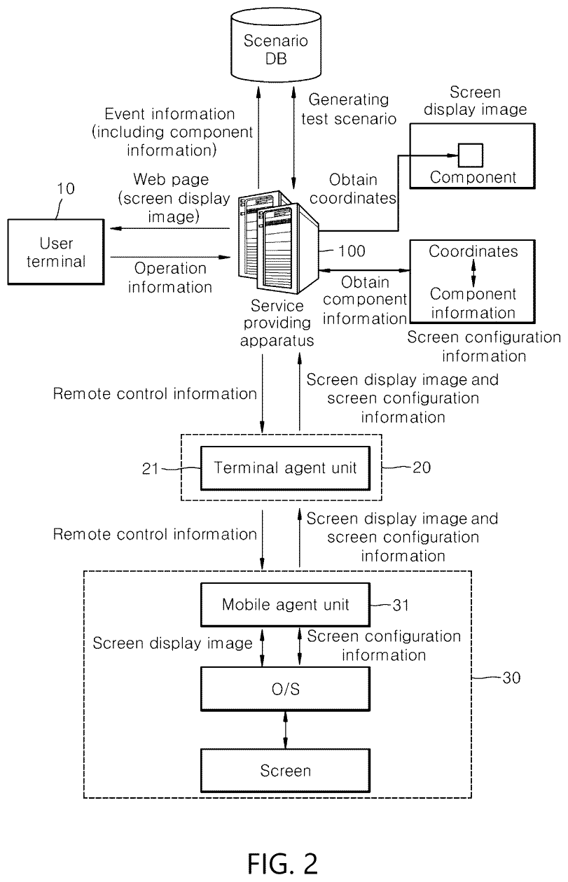

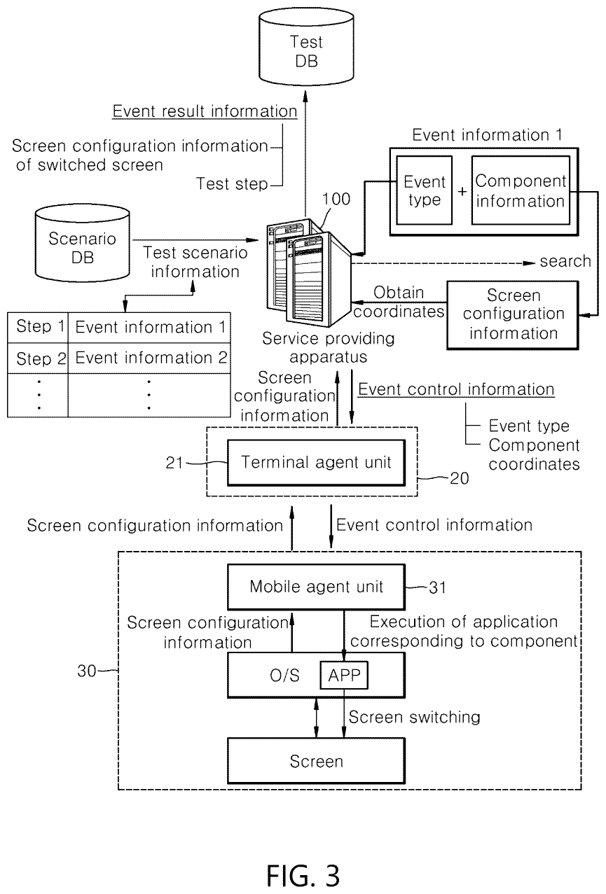

FIGS. 2 and 3 are operational example diagrams of a method for providing a service for testing an application of the service providing system according to an embodiment of the present disclosure.

Prior to the description, the mobile agent unit 31 configured in the mobile terminal 30 may communicate with various external devices (for example, the management terminal 20) through the terminal communication unit configured in the mobile device 30, and the terminal agent unit 21 configured in the management terminal 20 may communicate with the various external devices (for example, the mobile terminal 30 and the service providing apparatus 100) through a terminal communication unit or configured in the management device 20, and hereinafter, a communication configuration of the mobile agent unit 32 or the terminal agent unit 22 via the terminal communication unit will be omitted.

In addition, the mobile terminal 30 may be connected to the management terminal 20 through wired communication, and the mobile terminal 30 and the management terminal 20 may communicate with each other based on the wired communication.

First, a process of creating (generating) the test scenario of the service providing system will be described in detail with reference to FIG. 2.

The service providing apparatus 100 may provide a web page including a development interface required for creating a test scenario for performing a test for an application installed in the mobile terminal 30 from a state before execution of the application to a state in which the application is terminated, to the user terminal 10 that is a subject of creating the test scenario.

Accordingly, the user terminal 10 may connect to the web page, receive the web page, and create the test scenario through the web page.

In addition, one or more mobile terminals 30 may be communicatively connected to the management terminal 20, and the service providing apparatus 100 may include a terminal DB in which one or more mobile terminal information respectively corresponding to one or more mobile terminals 30 positioned locally and management terminal information for the management terminal 20 connected to the one or more mobile terminal 30 are stored.

In this case, the mobile terminal information may include terminal specification information including a terminal type, a screen size, a screen mode (for example, a horizontal screen mode, a vertical screen mode, a single screen mode, a multi-screen mode, or the like) of the mobile terminal 30, and terminal identification information corresponding to the mobile terminal 30.

Further, the management terminal information may include terminal identification information corresponding to the management terminal 20, mobile terminal-specific terminal identification information connected to the management terminal 20, and the like.

In addition, the service providing apparatus 100 may generate terminal list information including the one or more mobile terminal information and provide the generated terminal list information to the user terminal 10 through the web page, and when receiving selection information including terminal identification information for a specific mobile terminal 30 selected from the terminal list information by the user terminal 10, create a test scenario based on the specific mobile terminal 30 corresponding to the selection information.

Further, the service providing apparatus 100 may transmit, to the management terminal 20, screen request information for requesting a screen display image and screen configuration information to the mobile agent unit 31 of the specific mobile terminal 30 corresponding to the selection information.

Accordingly, the terminal agent unit 21 of the management terminal 20 may identify the specific mobile terminal 30 based on the terminal identification information included in the screen request information when receiving the screen request information, and transmit the screen request information to the identified specific mobile terminal 30.

When receiving the screen request information, the mobile agent unit 31 of the specific mobile terminal 30 may generate a screen displayed on the mobile terminal 30 as an image (hereinafter, a screen display image) according to the execution of the screen or the application displayed on the mobile device 30, and transmit the generated image to the management terminal 20, and may also transmit the image to the management terminal 20 in a streaming scheme.

In this case, the screen display image may be generated by an operating system of the mobile terminal 30, and the mobile agent unit 31 may receive the generated screen display image from the operating system and transmit the screen display image to the management terminal 20.

In addition, the mobile agent unit 31 may obtain, from the operating system, screen configuration information in an extensible Markup Language (XML) format used for displaying a screen corresponding to the screen display image in the operating system, and transmit the screen configuration information to the terminal agent unit 21.

As an example, an Android-based operating system operating on the mobile terminal 30 may generate a screen display image for a screen displayed on the terminal display unit of the mobile terminal 30, and may generate a screen display content of the screen as XML data.

Accordingly, the mobile agent unit 31 operating based on the operating system may obtain the screen display image from the operating system in conjunction with the operating system, and may obtain the screen configuration information in the XML format for the screen display content.

In this case, the screen configuration information may include a position (coordinate) of a component and component information about the component for each component (element) constituting the screen corresponding to the screen display image, and the component information may include component identification information about the component, a description of the component, and the like.

In addition, the position of the component may be configured as a coordinate-based boundary region (or selection effective region) in which selection of the component is effective.

In addition, the components (or elements) may include all kinds of components that may be displayed and operated on the screen such as an icon, a menu, an item, a text input window, and the like.

In addition, the terminal agent unit 21 of the management terminal 20 may transmit the screen display image received from the mobile terminal 30 to the service providing apparatus 100 in the streaming scheme.

In addition, the service providing apparatus 100 may transmit the screen display image received from the terminal agent unit 21 of the management terminal 20 to the user terminal 10 in the streaming scheme, and may provide the screen display image to the user terminal 10 to be displayed through the development interface included in the web page each time the screen display image is received from the terminal agents unit 21.

Further, the service providing apparatus 100 may receive the screen configuration information from the terminal agent unit 21 of the management terminal 20.

In addition, the service providing apparatus 100 may receive operation information according to an operation input for the specific mobile terminal 30 using the screen display image from the user terminal 10 through the web page, and may receive the operation information in real time.

In this case, the operation information may be information about an operation input to any one of the one or more components included in the screen display image.

Further, the screen configuration information may include a boundary region for each component constituting the screen corresponding to the screen display image.

In addition, the service providing apparatus 100 may receive operation information including coordinates corresponding to positions of cursors moving on the development interface from the user terminal 10 in real time, and when the coordinates according to the operation information in the screen configuration information are included in a boundary region corresponding to a specific component of the screen, generate a screen display image in which the boundary region corresponding to the specific component is displayed differently from other regions included in the screen display image based on the screen display image, and transmit the screen display image to the user terminal 10.

Accordingly, the user terminal 10 may receive and display the screen display image in which the boundary region corresponding to the specific component is displayed differently from other regions in the screen display image from the service providing apparatus 100, and thereby support a user (developer) of the user terminal 10 to easily grasp the component corresponding to the position of the cursor executed in the user terminal 10.

In addition, when operation information (hereinafter, referred to as first operation information) including an input event for an operation for a specific component and coordinates at which the input event is generated is received based on the screen display image, the service providing apparatus 100 may check a preset event type corresponding to the input event according to the first operation information based on preset setting information, and generate remote control information corresponding to the first operation information for operating the specific mobile terminal 30 positioned remotely based on the coordinates according to the first operation information and the event type corresponding to the first operation information.

In this case, the event type may include touch, click, drag, drop, swipe, text input, and the like.

In addition, setting information in which event types for a plurality of different input events are set in advance may be stored in advance in the service providing apparatus 100, and the service providing apparatus 100 may identify (confirm) an event type corresponding to an input event of the first operation information based on the setting information.

In this case, the input event and the event type may be the same as each other.

Further, the service providing apparatus 100 may identify and extract, from the screen configuration information, component information of a component corresponding to the coordinates according to the first operation information among one or more components constituting a screen displayed on the specific mobile terminal 30 corresponding to the screen configuration information based on the screen configuration information.

Accordingly, the service providing apparatus 100 may generate event information (hereinafter, referred to as first event information) including the event type corresponding to the first operation information received from the user terminal 10 based on the screen display image and component information (hereinafter, referred to as first component information) extracted to correspond to the operation information.

In this case, the service providing apparatus 100 may provide the event information to the user terminal 10 so that the event information may be edited through the development interface so that the user may intuitively grasp a unit operation corresponding to the event information, and may receive event description information for the event information from the user terminal 10 and include the event description information in the event information.

Further, the service providing apparatus 100 may store the first event information in a scenario DB included in the storage unit.

In this case, the service providing apparatus 100 may receive scenario identification information for creating (generating) a test scenario to the user terminal 10 through the web page, store the scenario identification information in the scenario DB, and match the first event information with the scenario identification information and store the first event information and the scenario identification information in the scenario DB.

Further, the service providing apparatus 100 may transmit the remote control information to the terminal agent unit 21 of the management terminal 20.

Further, the terminal agent unit 21 may transmit the remote control information to the specific mobile terminal 30 corresponding to the remote control information upon receiving the remote control information.

Accordingly, the mobile agent unit 31 configured in the specific mobile terminal 30 may perform a function of operating a specific component corresponding to coordinates according to the remote control information based on the remote control information among one or more components configured on the screen corresponding to the screen display image according to an input event corresponding to an event type according to the remote controls information when the remote control information is received, and execute an application corresponding to the specific component or a function of the application.

As an example, when the screen display image transmitted to the service providing apparatus 100 is an application selection screen including one or more application icons, a specific component corresponding to the coordinates according to the remote control information is an icon for executing the application, and a corresponding input type is a click, the mobile agent unit 31 may perform a function of selecting the icon to execute an application corresponding to the icon, and accordingly, the mobile terminal 30 may switch from the application selection screen to a start screen according to a start of execution of the application to display the start screen.

Alternatively, the mobile agent unit 31 may perform a function of selecting an application providing menu that is a component corresponding to coordinates according to the remote control information among one or more components constituting a screen in a state in which the application is executed, and accordingly perform a function of switching to a menu screen that displays one or more items included in the application providing menu in the mobile terminal 30, and display the menu screen.

Further, the mobile agent unit 31 may transmit, to the terminal agent unit 21, a screen display image of an execution screen (a current execution screen or a current display screen) that is a screen converted (switched) by an application executed by performing a function corresponding to the remote control information, and may transmit XML-format screen configuration information corresponding to the converted execution screen to the terminal agent units 21.

In addition, the terminal agent unit 21 may transmit the screen display image corresponding to the execution screen received from the mobile terminal 30 to the service providing apparatus 100 in the streaming scheme, and transmit the screen configuration information corresponding to the execution screen received from the mobile device 30 to the service provision apparatus 100.

Accordingly, the service providing apparatus 100 may provide a web page including the screen display image corresponding to the execution screen to the user terminal 10, and receive other operation information (hereinafter, referred to as second operation information) corresponding to the execution screen from the user terminal 10.

In this case, the user terminal 10 may transmit the second operation information including the coordinates corresponding to the selected component and the input event corresponding to the user input to the service providing apparatus 100 based on the user input to any selected one of the one or more components included in the execution screen in the screen display image for the execution screen.

Accordingly, upon receiving the second operation information generated based on the screen display image corresponding to the execution screen from the user terminal 10, the service providing apparatus 100 may search for the screen configuration information corresponding to the execution screen based on the coordinates according to the second operation information, identify the component information (hereinafter, referred to as second component information) corresponding to the coordinates according the second operation information from the screen configuration information according to the execution screen, and extract the identified second component information.

Further, the service providing apparatus 100 may identify a preset event type corresponding to an input event according to the second operation information based on the setting information, generate event information (hereinafter, referred to as second event information) including the event type corresponding to the second operation information and the second component information, and then match the generated event information with the scenario identification information or the first event information to cumulatively store the second event information in the scenario DB so as to be consecutive to the first event information in a subordinate order.

Further, the service providing apparatus 100 may generate remote control information including coordinates corresponding to the second operation information and the event type corresponding to the second operation information in correspondence with the second operation information, and transmit the remote control information corresponding to the second operated information to the terminal agent unit 21 of the management terminal 20.

Accordingly, the terminal agent unit 21 may transmit the remote control information to the mobile agent unit 31 of the mobile terminal 30, and the mobile agent unit 21 may perform a function according to an input event corresponding to the remote control information on a component corresponding to the second component information according to the remote control information to transmit a screen display image and screen configuration information for the execution screen converted by the application executed by the remote control information corresponding to the second operation information to the service providing apparatus 100 through the management terminal 20.

In addition, when the service providing apparatus 100 receives the third operation information after generating the second event information based on the second operation information, the service providing apparatus 100 may generate third event information in the same scheme as generating the first event information based on the first operation information based on the screen display image and the screen configuration information corresponding to the converted execution screen, or generating the second event Information based on the second operation information, match the third event information with the second event information, and cumulatively store the third event information as event information subsequent to the second event information in the subordinate order, and generate the remote control information corresponding to the third operation information in conjunction with the mobile agent unit 31 through the terminal agent unit 21 and transmit the remote control information to the specific mobile terminal 30 through the management terminal 20 in the same scheme of transmitting the remote control information described above.

Thereafter, the service providing apparatus 100 may also generate one or more event information following the third event information in the same scheme as the above-described first to third event information generation schemes, and may match the one or more generated event information with previously generated event information or scenario identification information according to a generation order and store the one or more generated event information in the scenario DB.

In addition, the user terminal 10 may generate creation completion information (or creation termination information) for completion (termination) of creation of a test scenario based on the development interface according to a user input, and transmit the generated creation completion (termination) information to the service providing apparatus 100.

As an example, the user terminal 10 may generate and transmit the creation completion information to the service providing apparatus 100 when a completion button for completing creation of the test scenario included in the development interface of the web page is selected according to the user input.

Accordingly, upon receiving the creation completion information from the user terminal 10, the service providing apparatus 100 may determine that the creation of the test scenario is completed based on the creation completion information, and generate the test scenario information based on one or more event information and scenario identification information cumulatively stored in the scenario DB.

In this case, the test scenario information may include the one or more event information.

Further, the service providing apparatus 100 may set a test step for each event information according to a generation order (or a storage order) of each of the one or more event information in a process of generating the test scenario information, and may set the test step for each of the event information such that the test step is advanced as the generation order is advanced.

As an example, the service providing apparatus 100 may set the first test step that is the most senior to the first event information that is first generated, set a second test step to the second event information that is generated in a next order, set a third test step to the third event information that is created after the second event information, and generate the test scenario information including the event information for each of the first to third test steps.

In this case, the service providing apparatus 100 may generate test scenario information including event information for each of one or more test steps in the form of a script.

Further, the service providing apparatus 100 may store the test scenario information in the scenario DB.

Meanwhile, as illustrated in FIG. 3, the service providing apparatus 100 may perform application testing on each of the one or more mobile terminals 30 connected to the management terminal 20 based on the test scenario information stored in the scenario DB when the test scenario creation by the user terminal 10 is completed, which will be described in detail.

The service providing apparatus 100 may select another mobile terminal 30 in communication with the management terminal 20 as a test terminal for testing according to the test scenario information, perform testing for the test terminal based on event information corresponding to a test step included in the test scenario information, identify component information according to the event information included in the test scene information from screen configuration information received from the test terminal, extract coordinates corresponding to the identified component information from the screen configuration information, generate event control information for performing a function according to the event information on a component corresponding to the identified components information based on the extracted coordinates and the event information, and then transmit the event control information to the terminal agent unit 21 of the management terminal 20 so that the event control information is transmitted to the test terminal; receive screen configuration information for an execution screen switched by an application executed by the test terminal by performing the function according to the event control information as a response to the event control information from the management terminal 20, and then perform testing for each test step to generate event result information including the screen configuration information for the execution screen and the test step corresponding to the event control information, and generate test result information including the event result information for each test step at the time of termination of testing for all test steps.

As an example, the service providing apparatus 100 may extract the test scenario information stored in the scenario DB according to pre-stored schedule information or test request information received from the user terminal 10.

In addition, the service providing apparatus 100 may select any one of the one or more mobile terminals 30 connected to the management terminal 20 as a test target and transmit test start information to the management terminal 20, and the terminal agent unit 21 of the management terminal 20 may transmit the test start information to the mobile terminal 30.

Accordingly, the mobile agent unit 31 of the mobile terminal 30 (hereinafter, referred to as a test terminal) selected as the test target may transmit screen configuration information on a current screen to the management terminal 20 when receiving the test start information, and the terminal agent unit 21 of the management terminal 20 may transmit the received screen configuration information to the service providing apparatus 100.

Further, the service providing apparatus 100 may extract the scenario identification information from the extracted test scenario information, extract terminal identification information for the test terminal from the terminal DB, match the extracted terminal identification with the scenario identification information, and store the matching information in a test DB included in the storage unit.

In this case, the service providing apparatus 100 may store the test scenario information in the scenario DB instead of the scenario identification information.

Further, the service providing apparatus 100 may extract component information of event information corresponding to a highest priority test step from the test scenario information when receiving the screen configuration information, obtain coordinates corresponding to the extracted component information from the screen configuration information while identifying the extracted component information in the screen configuration information, and generate event control information including the obtained coordinates and an event type included in the event information and transmit the event control information to the management terminal 20.

Further, the terminal agent unit 21 of the management terminal 20 may transmit the event control information to the test terminal.

In addition, the mobile agent unit 31 of the test terminal may identify, on the current screen, a component corresponding to coordinates according to the event control information when receiving the event control information, perform a function corresponding to the input event on the component to cause an application to be executed according to the performance of the function, and cause the screen to be switched by the executed application.

Further, the mobile agent unit 31 may transmit screen configuration information corresponding to the switched screen to the management terminal 20, and the terminal agent unit 21 of the management terminal 20 may transmit the screen configuration information corresponding to the switched screen to the service providing apparatus 100.

Further, the service providing apparatus 100 may generate event result information including the screen configuration information corresponding to the switched screen received in response to the event control information, set a test step corresponding to the event control Information in the event result information, match the event result information with the scenario identification information, and store the event result information in the test DB.

Further, the service providing apparatus 100 may identify, in the test scenario information, event information matched to a test step corresponding to a next order of the highest-priority test step when receiving the screen configuration information corresponding to the switched screen, obtain coordinates corresponding to component information according to the identified event information from the screen configuration information corresponding to the switched screen, and generate other event control information including the obtained coordinates and an event type included in the identified event information, and transmit the generated other event control information to the test terminal through the management terminal 20.

In addition, the mobile agent unit 31 of the test terminal may identify a component corresponding to the coordinates included in the other event control information in the switched screen when receiving the other event control data, perform a function according to an input event included in the other event control information with respect to the identified component, and transmit, to the management terminal 20, screen configuration information for another screen switched by an application executed according to performance of the function according to the other events control information, and the terminal agent unit 21 of the management terminal 20 may transmit the screen configuration information on the switched other screen to the service providing apparatus 100.

Accordingly, the service providing apparatus 100 may generate other event result information in which a test step corresponding to the other event control information is set while including the screen configuration information for the switched other screen when receiving the screen configuration information for the switched other screen, and then match the generated other event result information with the scenario identification information, and store the matched information in the test DB.

As described above, the service providing apparatus 100 may perform the test as described above for each of the remaining test steps included in the test scenario information in link with the mobile agent unit 31 of the test terminal through the terminal agent unit 21 of the management terminal 20.

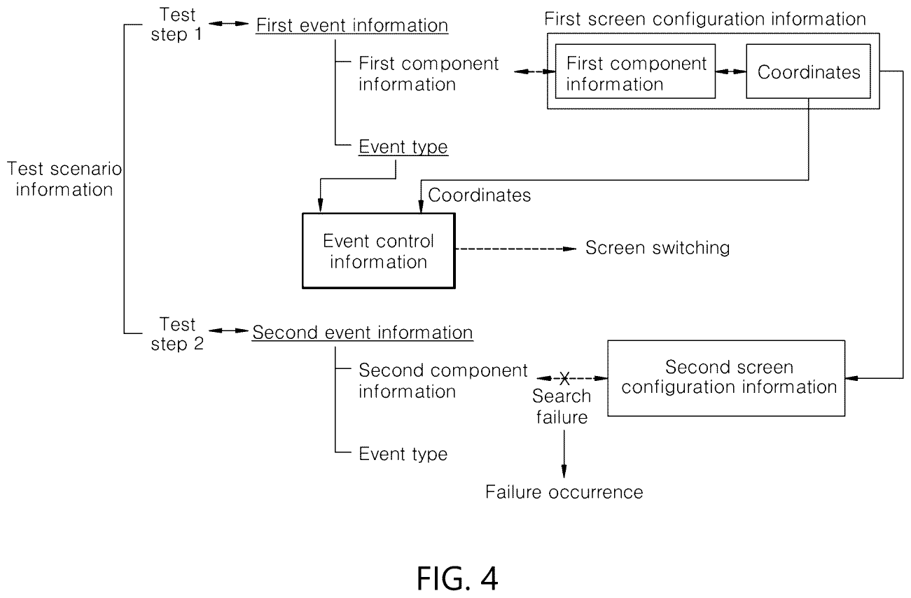

Meanwhile, the service providing apparatus 100 may determine whether a failure occurs during a test process, which will be described in detail with reference to FIG. 4.

When the event result information is generated in the test process using the test scenario information, the service providing apparatus 100 may check component information in event information corresponding to another test step corresponding to a next order of the test step included in the event result information based on the test scenario information, and check the screen configuration information in the event result Information.

Further, the service providing apparatus 100 may determine whether the component information of the other test step exists in the screen configuration information included in the event result information, and determine whether the failure occurs in the event result information according to whether the component information in the other test step exists in the screen configuration information corresponding to the event result information.

That is, when the component information of the other test step does not exist in the screen configuration information according to the event result information, the service providing apparatus 100 may determine that the failure occurs in the test step according to the event result information, generate failure occurrence information including the event result information and log information on the occurrence of the failure, and match the failure occurrence information with the scenario identification information, and store the matched information in the test DB.

In this case, the service providing apparatus 100 may extract terminal identification information of the test terminal corresponding to the event result information from the terminal DB when determining that the failure occurs, and include the terminal identification information in the failure occurrence information.

In addition, the service providing apparatus 100 may generate test result information based on the event result information for each test step stored in the test DB when the failure does not occur during a test process according to the test scenario information in a state in which all test steps according to the test scene information are completed, and then match the test result information with the scenario identification information and store the test result information in the test DB.

In this case, the test result information may include one or more event result information respectively corresponding to one or more test steps.

In addition, when the failure occurs during the test process according to the test scenario information, the service providing apparatus 100 may generate test result information including the failure occurrence information, match the test result information with the scenario identification information, and store the test result information in the test DB.

In this case, the service providing apparatus 100 may extract terminal identification information of the test terminal corresponding to the event result information from the terminal DB when determining that the failure occurs, and include the terminal identification information in the failure occurrence information.

In addition, the service providing apparatus 100 may generate test termination information for notifying the test termination when all test steps according to the test scenario information are completed (terminated) or when the failure occurs, and transmit the test termination information to the test terminal through the management terminal 20.

Meanwhile, the service providing apparatus 100 may sequentially automatically transmit event control information for each of one or more test steps according to the test scenario information to perform a test, check a response time for each test step according to a reception time of each of the one or more different screen configuration information, apply the response time for each of the test steps to a preset quality measurement algorithm to measure a quality, and generate quality information on the measured quality and include the quality information in the test result information.

In addition, the service providing apparatus 100 may transmit video request information for requesting a video related to a specific test step corresponding to the failure occurrence information to the terminal agent 21 of the management terminal 20 when generating the failure occurrence information, and the terminal agent 21 may transmit the video request information to the test terminal.

Further, the mobile agent unit 31 may record a screen of the test terminal from the time of receiving the test start information to generate a video, generate recording information including the video, and store the recording information in a terminal storage unit configured in the mobile terminal 30.

In this case, the video included in the recording information may be an image generated by recording the screen of the mobile terminal 30 from the start of the test according to the test scenario information to the termination according to the test termination information.

In addition, the mobile agent unit 31 may transmit the recording information to the terminal agent unit 21 of the management terminal 20 when receiving the video request information, and the terminal agent unit 41 may transmit the recording information to the service providing apparatus 100.

In addition, the service providing apparatus 100 may match the recording information with the scenario identification information when receiving the recording information and store the matching information in the test DB, and may include the recording information in the test result information.

In addition, the service providing apparatus 100 may transmit notification information for notifying a failure occurrence (abnormality occurrence) to the user terminal 10 or a preset contact when generating the test result information including the failure occurrence information, and may transmit the notification information including link information connectable to the test result information in which the failure occurrence information is included.

In this way, the service providing apparatus 100 may provide a user or a manager who manages the application test according to the test scenario information to be able to confirm a failure occurrence state through a video while notifying the failure occurrence.

Alternatively, based on the quality information included in the test result information, the service providing apparatus 100 may determine that a delay occurs or an error occurs in an execution process of an application when a preset quality criterion is not satisfied, and transmit the video request information to the test terminal, and may generate the notification information corresponding to the test result information that does not satisfy the quality criterion, and transmit the notification information to the user terminal 10 or a preset contact.

As described above, the present disclosure supports a mobile terminal to conveniently create a test scenario for testing an application on a web-based basis, thereby improving the case of creating an automated script-based test scenario, and also supports a test scenario to be configured based on the component itself rather than the coordinates of the component when operating the component for executing a function of an application installed in the mobile terminal to generate a test scenario that is universally applicable to all types of mobile terminals having different screen sizes or screen structures, thereby greatly increasing the efficiency of creating the test scenario.

In addition, according to the present disclosure, it is possible to determine a failure based on components for each test step constituting a test scenario, and it is possible to increase the accuracy of the failure determination while providing a clear criterion for the failure determination, so that it is possible to greatly increase the reliability and accuracy of the application test.

In addition, according to the present disclosure, it is possible to increase the convenience of creating a script for a test scenario by automatically generating and editing event information on a unit operation of a scenario by checking information on a component in a screen designated by a user, and it is possible to improve the user convenience by supporting a test operation to be intuitively grasped by checking only the script.

In addition, according to the present disclosure invention, it is possible to support easily grasping an abnormality of a screen switching operation according to the presence or absence of a component (element) in a screen set in advance when a screen is switched according to a change of a test step in a process of performing an application test using a test scenario, to support enabling real-time check of a test state without screen omission or delay by recording automatic test content separately from streaming in a local mobile terminal and, if necessary, transmitting a recorded video file to the service providing apparatus, to support facilitating determination of a failure or quality, and to support accurately grasping a test situation and facilitating analysis of a failure content through a recorded video.

Based on the above-described configuration, a detailed configuration of the service providing apparatus 100 according to an embodiment of the present disclosure will be described.

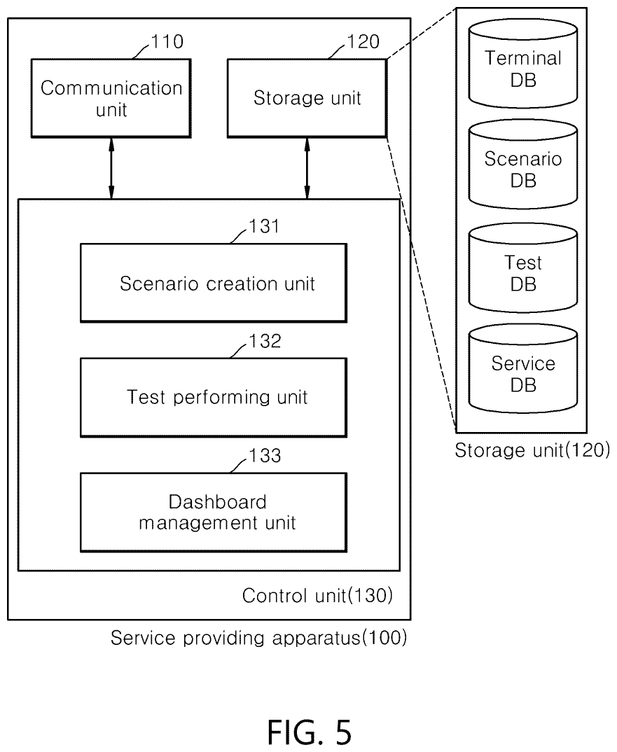

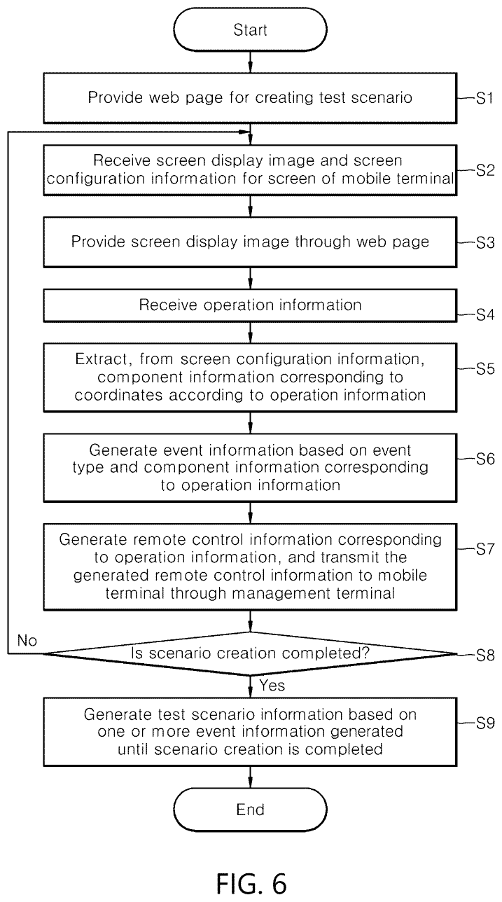

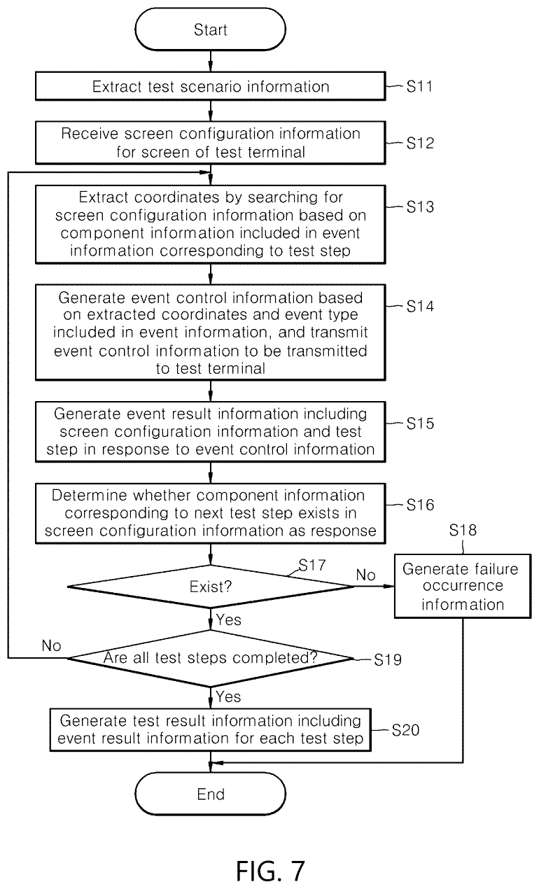

FIG. 5 is a configuration diagram of an apparatus 100 for providing a service for testing an application according to an embodiment of the present disclosure, and FIGS. 6 and 7 are flowcharts of a method for providing a service for testing an application of the service providing apparatus 100 according to an embodiment of the present disclosure.

As illustrated, the service providing apparatus 100 according to an embodiment of the present disclosure may be configured to include a communication unit 110, a storage unit 120, and a control unit 130.

First, the communication unit 110 may communicate with the user terminal 10, the one or more management terminals 20, and the like via the communication network.

In this case, each of the one or more management terminals 20 may be configured to communicate with one or more mobile terminals 30.

In addition, the storage unit 120 may store various kinds of information, and the storage unit 120 may be configured in various forms such as a hard disk drive (HDD) and a solid state drive (SSD), and may be configured as a DB or may be configured to include one or more DBs.

As an example, the storage unit 120 may be configured to include a service DB in which information related to a web page including a development interface is stored, a scenario DB in which the test scenario information is stored, a test DB in which test result information is stored, and a terminal DB in which one or more management terminal information respectively corresponding to the one or more management terminals 20 and one or more mobile terminal information respectively corresponding to the one or more mobile terminals 30 are stored.

In addition, the control unit 130 performs an overall control function of the service providing apparatus 100, and the control unit 130 may include a RAM, a ROM, a CPU, a GPU, and a bus, and the RAM, the ROM, the CPU, the GPU, etc. may be connected to each other via the bus.

In addition, the communication unit 120 and the storage unit 130 may also be configured to be included in the control unit 110.

In addition, the control unit 130 may perform an overall control function of the service providing apparatus 100, and may be configured to include a scenario creation unit 131, a test performing unit 132, a dashboard management unit 133, and the like.

In this case, the control unit 130 and at least one of various components constituting the control unit 130 may communicate with the manager terminal and an external server via the communication unit 110. Hereinafter, the communication configuration through the communication unit 110 will be omitted.

A plurality of components constituting the control unit 130 may be implemented by a processor capable of processing data and the like, and respective components may be separately implemented by different processors or also functionally separated within one processor.

In addition, the service providing apparatus 100 may also be configured with a system configuration in which the scenario creation unit 131, the test performing unit 132, and the dashboard management unit 133 are respectively configured with individual servers and communicate with each other, and the service DB, the test DB, the scenario DB, and the terminal DB may also be configured as individual servers or configured to be included in at least one of the scenario creation unit 131, the test performing units 132, and the dashboard management unit 133 so as to be included in the service providing apparatus 100.

First, an example of the operation of the scenario creation unit 131 will be described with reference to the flowchart of FIG. 6.

The scenario creation unit 131 may provide a web page for creating a test scenario including the development interface to the user terminal 10 connected to the service providing apparatus 100 (S1).

In this way, the scenario creation unit 131 may create a test scenario while transmitting and receiving information to and from the user terminal 10 based on the web page.

In addition, the service providing apparatus 131 may generate terminal list information including mobile terminal information for each of one or more mobile terminals for creating the test scenario based on the terminal DB and provide the generated terminal list information to the user terminal 10 through the web page, and when receiving selection information including terminal identification information for a specific mobile terminal 30 selected from the terminal list information by the user terminal 10, create a test scenario based on the specific mobile terminal 30 corresponding to the selection information.

Further, the scenario creation unit 131 may transmit, to the management terminal 20, screen request information for requesting a screen display image and screen configuration information to the mobile agent unit 31 of the specific mobile terminal 30 corresponding to the selection information.

Accordingly, the scenario creation unit 131 may receive the screen configuration information corresponding to the screen display image from the management terminal 20 while receiving the screen display image of the specific mobile terminal 30 from the management terminals 20 in a streaming scheme (S2).

In addition, the scenario creation unit 131 may transmit the screen display image to the user terminal 10 in the streaming scheme each time the screen display image is received from the management terminal 20, and may cause the user terminal 10 to display the received screen display image through a development interface included in the web page (S3).

In addition, the scenario creation unit 131 may receive operation information according to an operation input for the specific mobile terminal 30 using the screen display image from the user terminal 10 through the web page in real time.

In addition, when operation information (hereinafter, referred to as first operation information) including an input event for an operation for a specific component and coordinates at which the input event occurs is received based on the screen display image, the scenario creation unit 131 may check a preset event type corresponding to an input event according to the first operation information based on preset setting information.

In this case, the event type may include touch, click, drag, drop, swipe, text input, or the like, and the event type may be the same as or include the input event.

In addition, the scenario creation unit 131 may include setting information in which event types for a plurality of different input events are set in advance, and identify (confirm) an event type corresponding to an input event of the first operation information based on the setting information.

Further, the scenario creation unit 131 may identify and extract, from the screen configuration information, component information of a component corresponding to the coordinates according to the first operation information among one or more components constituting a screen displayed on the specific mobile terminal 30 corresponding to the screen configuration information based on the screen configuration information (S5).

In this case, the component information may be information that may identify a component.

Accordingly, the scenario creation unit 131 may generate event information (hereinafter, referred to as first event information) including the event type corresponding to the first operation information received from the user terminal 10 based on the screen display image and component information (hereinafter, referred to as first component information) extracted to correspond to the operation information (S6).

Further, the scenario creation unit 131 may store the first event information in a scenario DB included in the storage unit 120.

In this case, the scenario creation unit 131 may receive scenario identification information for creating (generating) a test scenario to the user terminal 10 through the web page, store the scenario identification information in the scenario DB, and match the first event information with the scenario identification information and store the first event information and the scenario identification information in the scenario DB.

In addition, the scenario creation unit 131 may generate remote control information corresponding to the first operation information for operating the specific mobile terminal 30 positioned remotely based on the coordinates according to the first operation information and the event type corresponding to the first operation information, and may transmit the remote control information to the management terminal 20 to allow the remote control information to be transmitted to the specific mobile terminal 30 through the management terminal 20 (S7).

Accordingly, the mobile agent unit 31 configured in the specific mobile terminal 30 may perform a function of operating a specific component corresponding to coordinates according to the remote control information based on the remote control information among one or more components configured on the screen corresponding to the screen display image according to an input event corresponding to an event type according to the remote controls information when the remote control information is received.

Further, the mobile agent unit 31 may transmit, to the terminal agent unit 21 of the management terminal 20, a screen display image of an execution screen that is a screen converted (switched) by an application executed from an existing screen by performing a function corresponding to the remote control information, and may transmit XML-format screen configuration information corresponding to the execution screen to the terminal agent units 21.

In addition, the terminal agent unit 21 may transmit the screen display image corresponding to the execution screen received from the mobile terminal 30 to the service providing apparatus 100 in the streaming scheme, and transmit the screen configuration information corresponding to the execution scene received from the mobile device 30 to the service provision apparatus 100.

Accordingly, the scenario creation unit 131 may provide the screen display image corresponding to the execution screen to the user terminal 10, and receive operation information corresponding to the execution screen from the user terminal 10.

In this case, the user terminal 10 may transmit the second operation information including an input event for operating the selected component and coordinates (a location (coordinates) where the input event occurs) corresponding to the input event to the service providing apparatus 100 based on the user input to any selected one of the one or more components included in the execution screen in the screen display image for the execution screen.

Accordingly, upon receiving the second operation information from the user terminal 10, the scenario creation unit 131 may search for the screen configuration information corresponding to the execution screen based on the coordinates according to the second operation information, identify the component information (hereinafter, referred to as second component information) corresponding to the coordinates according the second operation information from the screen configuration information according to the execution screen, and extract the identified second component information from the screen configuration information.

Further, the scenario creation unit 131 may identify a preset event type corresponding to an input event according to the second operation information based on the setting information, generate event information (hereinafter, referred to as second event information) including the event type corresponding to the second operation information and the second component information, and then match the generated event information with the first event information to cumulatively store the second event information in the scenario DB so as to be consecutive to the first event information in a subordinate order.

In this case, the scenario creation unit 131 may match the second event information with the scenario identification information, and cumulatively store the matching information in the scenario DB.

Further, the scenario creation unit 131 may generate remote control information including coordinates corresponding to the second operation information and the event type corresponding to the second operation information in correspondence with the second operation information, and transmit the remote control information corresponding to the second operated information to the management terminal 20.

Accordingly, the terminal agent unit 21 of the management terminal 20 may transmit the remote control information corresponding to the second operation information to the mobile agent unit 31 of the specific mobile terminal 30, and the mobile agent unit 21 may perform a function according to the input event corresponding to the second operation information for the component corresponding to the second operational information on the execution screen according to the remote control information received from the management terminal 20.

In addition, the mobile agent unit 31 may switch the execution screen to another execution screen that is an execution result of an application executed by the specific mobile terminal 30 according to performing a function according to the remote control information corresponding to the second operation information, obtain a screen display image for the other execution screen from the operating system of the specific mobile terminal 30, and then transmit the screen display image to the service providing apparatus 100 through the management terminal 20 in the streaming scheme, and obtain screen configuration information for the other execution display image from the operating system and transmit the screen configuration information to the service providing apparatus 100 through the management terminal 20.

In addition, the scenario creation unit 131 may receive the screen display image and the screen configuration information corresponding to the other execution screen, and provide the screen display image corresponding to the other execution screen to the user terminal 10, and when receiving the third operation information including the input event from the user terminal 10 that generates the third operation information based on the screen display image corresponding to the other enforcement screen, the scenario creation unit 131 may generate third event information in the same scheme as generating the first event information based on the first operation information or generating the second event information based on the second operation information in link with the mobile agent unit 31 through the terminal agent unit 21, match the third event information with the second event information, and cumulatively store the third event information as event information following the second event information in the scenario DB in the subordinate order, and transmit the remote control information corresponding to the third operation information to the mobile agent unit 32 of the specific mobile terminal 30 through the management terminal 20 so that the function corresponding to the third operation information is performed.

Thereafter, the scenario creation unit 131 may also generate one or more event information following the third event information in the same scheme as the above-described first to third event information generation schemes, and may match the one or more generated event information with previously generated event information or scenario identification information according to a generation order and store the one or more generated event information in the scenario DB.

Further, upon receiving the creation completion information from the user terminal 10, the scenario creation unit 131 may determine that the creation of the test scenario is completed based on the creation completion information (S8), and generate the test scenario information based on one or more event information and scenario identification information cumulatively stored in the scenario DB (S9).

In this case, the test scenario information may include the one or more event information and the scenario identification information that match the scenario identification information.

Further, the scenario creation unit 131 may generate test scenario information in which a test step is set for each event information according to the generation order of the one or more events information, and may set the test step for each event information such that the test step is advanced as the generation order is advanced.

As an example, the scenario creation unit 131 may set the first test step that is the most senior to the first event information that is first generated, set a second test step to the second event information that is generated in a next order, set a third test step to the third event information that is created after the second event information, and generate the test scenario information including the event information for each of the first to third test steps.

In this case, the scenario creation unit 131 may generate test scenario information including event information for each of one or more test steps in the form of a script.

Further, the scenario creation unit 131 may store the test scenario information in the scenario DB.

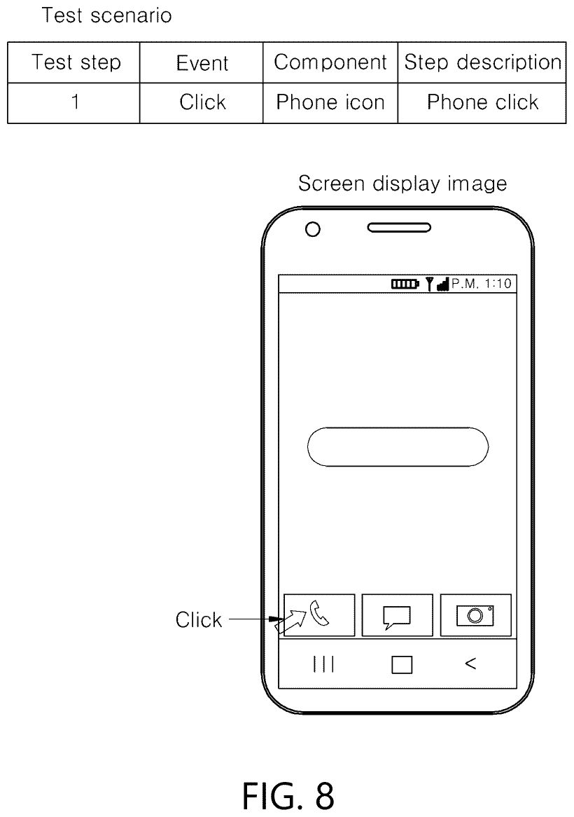

As an example of the above-described configuration, as illustrated in FIG. 8, when an input event in which a phone icon, which is a component included in the application selection screen, is clicked in the user terminal 10 based on a screen display image for the application selection screen including one or more application icons provided to the user terminal 10 occurs, the scenario creation unit 131 may receive, from the user terminal 10, first operation information including coordinates corresponding to a position at which the phone icon is clicked an input event for the click input.

In this case, the scenario creation unit 131 may receive the screen display image corresponding to the application selection screen and the first screen configuration information for the application selection screen received from the mobile agent unit 31 of the specific mobile terminal 30 through the terminal agent unit 21 of the management terminal 20 before receiving the first operation information, and may transmit the screen display image to the user terminal 10 to receive the first operation information from the user terminal 10.

Further, the scenario creation unit 131 may identify an event type corresponding to an input event according to the first operation information based on preset setting information upon receiving the first operation information.

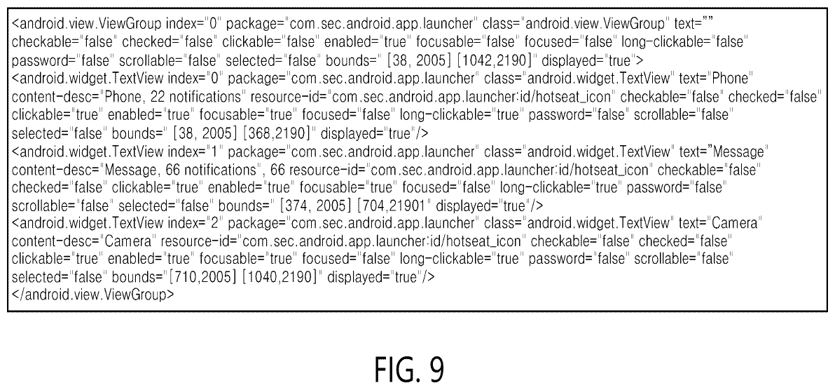

In addition, as illustrated in FIG. 9, the scenario creation unit 131 may identify first component information related to the phone icon corresponding to the coordinates included in the operation information from first screen configuration information corresponding to the application selection screen, and extract the first component information corresponding to the phone icon from the first screen configuration information.

Accordingly, the scenario creation unit 131 may generate first event information including an event type identified based on the first operation information and the first component information extracted from the first screen configuration information based on the first operation information, and then store the first event information in the scenario DB included in the storage unit 120.

In this case, the scenario creation unit 131 may match the first event information with the scenario identification information received from the user terminal 10 and stored in the scenario DB in order to generate the test scenario, and store the first event information in the scenario DB.

Further, the scenario creation unit 131 may generate first remote control information including coordinates according to the first operation information and an event type corresponding to an input event according to the first operation information, and transmit the generated first remote control information to the management terminal 20.

In this case, the first remote control information may include the same information as the first operation information, and may include terminal identification information of a specific mobile terminal 30 to be used for the scenario creation.

Accordingly, the terminal agent unit 21 configured in the management terminal 20 may transmit the first remote control information to the specific mobile terminal 30, and the mobile agent unit 31 configured in the specific mobile terminal 20 may perform a function of clicking the phone icon on the application selection screen based on the first remote control in order to cause a phone application corresponding to the phone icon to be executed in the specific mobile device 30 according to the performance of the function, so that a first execution screen according to the execution of the phone application is displayed in the specific mobile terminal 30, and obtain a screen display image corresponding to the first execution screen and second screen configuration information corresponding to the first execution screen from an operating body operating in the specific mobile terminal 30, and transmit the screen display image and the second screen configuration information to the management terminal 20.

The terminal agent unit 21 configured in the management terminal 20 may transmit the second screen configuration information to the service providing apparatus 100 while transmitting the screen display image received from the specific mobile terminal 30 to the service providing apparatus 100 in the streaming scheme.

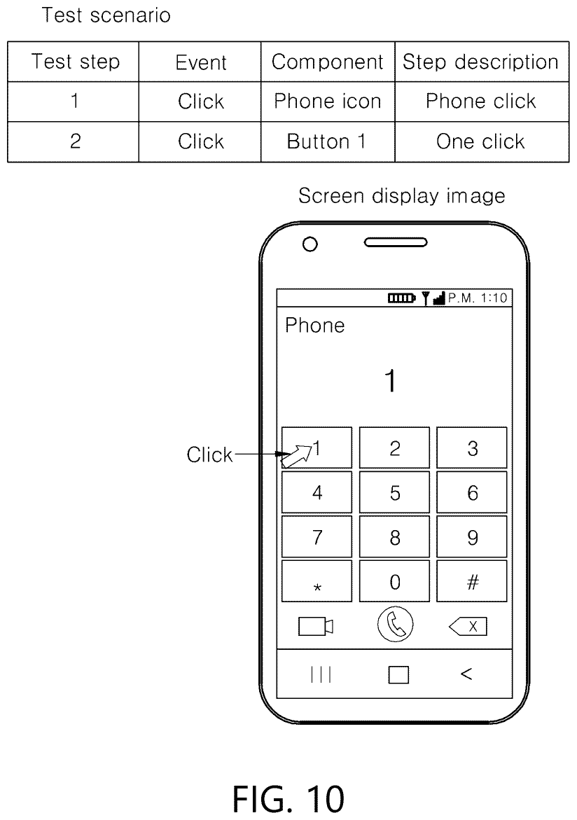

Accordingly, as illustrated in FIG. 10, the scenario creation unit 131 may transmit a screen display image for the first execution screen according to initial execution of the phone application to the user terminal 10, and receive second operation information including an input event according to a click of a button corresponding to “1” from the user terminal 10 among a plurality of components constituting the first execution screen.

Further, the scenario creation unit 131 may generate second remote control information including coordinates corresponding to the button and an event type corresponding to the click related input event according to the second operation information, and then transmit the generated second remote control information to the specific mobile terminal 30 through the management terminal 20.

In addition, the scenario creation unit 131 may extract second component information for the button corresponding to the coordinates included in the second operation information from the second screen configuration information, generate second event information including the event type and the second component information, and match the generated second event information with the first event information or the scenario identification information, and store the matching information in the scenario DB.

Further, the scenario creation unit 131 may receive, from the specific mobile terminal 30 that receives the second remote control information and performs the function for clicking the button, a screen display image for a second execution screen that is an execution screen converted to display ‘1’ in a number display window included in the first execution screen on the first execution screen, and the screen display image and third screen configuration information transmitted by the management terminal 20 that receives third screen configuration information corresponding to the second execution screen, and may transmit the screen display image to the user terminal 10.

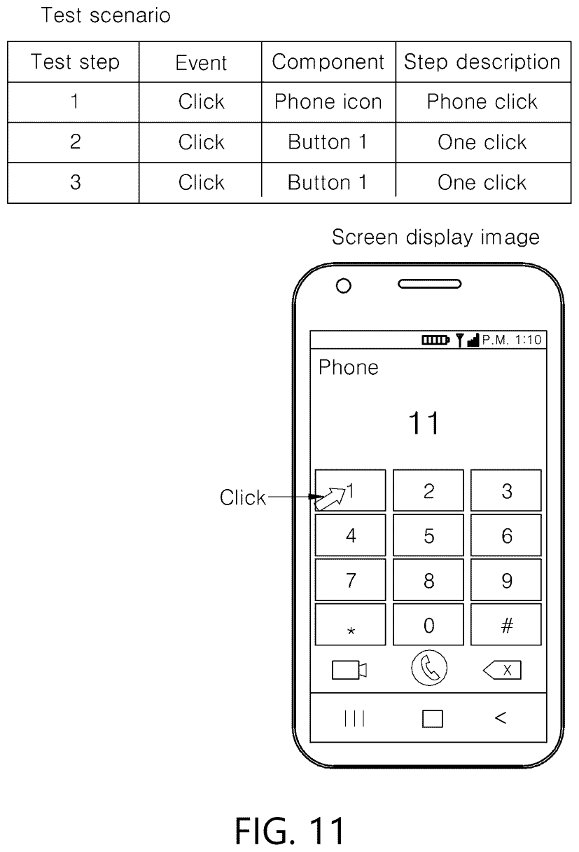

Further, as illustrated in FIG. 11, upon receiving the third operation information for the operation of clicking the button again from the user terminal 10, the scenario creation unit 131 may generate third event information including the event type corresponding to the third operation information and the third component information (or the second component information) corresponding to the button corresponding to ‘1’ based on the third screen configuration information while transmitting the third remote control information corresponding to the third operation information to the user terminal 10, and match the third event information with the second event information or the scenario identification information, and cumulatively store the matching information in the scenario DB.

Further, the scenario creation unit 131 may receive, from the specific mobile terminal 30 that receives the third remote control information and performs the function for clicking the button, the screen display image and fourth configuration information transmitted by the management terminal 20 that receives a screen display image for a third execution screen that is an execution screen converted to display ‘11’ in a number display window included in the second execution screen on the second execution screen by the telephone application, and fourth screen configuration information corresponding to the third execution screen, and transmit the screen display image to the user terminal 10.

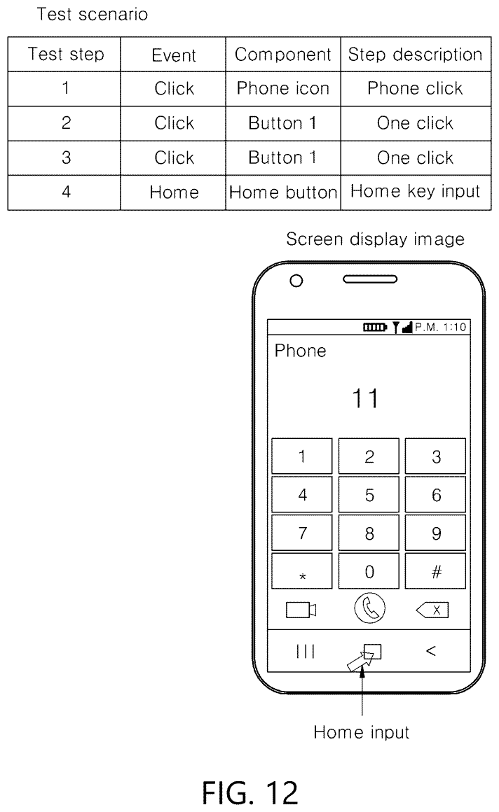

Further, as illustrated in FIG. 12, upon receiving fourth operation information for an operation of clicking a Home button again among a plurality of components included in the third execution screen from the user terminal 10, the scenario creation unit 131 may generate fourth event information including an event type corresponding to the fourth operation information and fourth component information corresponding to the Home button based on the fourth screen configuration information while transmitting fourth remote control information corresponding to the fourth operation information to the user terminal 10, and match the fourth event information with the third event information or the scenario identification information, and cumulatively store the matching information in the scenario DB.

Further, the scenario creation unit 131 may receive, from the specific mobile terminal 30 that receives the fourth remote control information and performs the function for clicking the Home button, the screen display image and fifth screen configuration information transmitted by the management terminal 20 that receives a screen display for the fourth execution screen and fifth screen configuration information corresponding to the fourth execution screen in a state in which the third execution screen is converted to a fourth execution screen which is an application selection screen, and transmit the screen display image to the user terminal 10.

Further, the scenario creation unit 131 may generate test scenario information including the first to fourth event information by setting a test step according to a generation order of the first event information, the second event information, the third event information, and the fourth event information matched with the scenario identification information stored in the scenario DB corresponding to the creation completion information when receiving the creation completion information for the creation completion of the test scenario from the user terminal 10, and may store the test scenario information in the scenario DB.

Meanwhile, the test performing unit 132 may perform an application test for each of the one or more mobile terminals 30 connected to the management terminal 20 based on the test scenario information, which will be described in detail with reference to the flowchart of FIG. 7.

As an example, the test performing unit 132 may extract the test scenario information stored in the scenario DB according to preset schedule information or test request information received from the user terminal 10.

In addition, the test performing unit 132 may select any one of the one or more mobile terminals 30 connected to the management terminal 20 as a test target, and receive screen configuration information transmitted by the mobile agent unit 31 of the mobile terminal 30 (test terminal) selected as the test target through the management terminal 20 (S12).

As a result, the test performing unit 132 may extract the scenario identification information from the extracted test scenario information, extract terminal identification information for the test terminal from the terminal DB, and match the extracted terminal identification information with the scenario identification information, and store the matching information in the test DB included in the storage unit.

In this case, the test performing unit 132 may also store the test scenario information in the test DB instead of the scenario identification information.

In addition, the test performing unit 132 may identify first component information corresponding to the first event information based on first event information corresponding to a first test step, which is a most advanced test step according to the test scenario information, in the screen configuration information (hereinafter, referred to as an 11-th screen configuration information) first transmitted by the mobile terminal 30 (hereinafter, referred to as a test terminal) that is the test target, and identify and extract coordinates corresponding to the first component information from the 11-th screen configuration information (S13).

In addition, the test performing unit 132 may generate first event control information including coordinates corresponding to the first component information and an event type according to the first event information, and transmit the first event control information to the terminal agent unit 21 of the management terminal 20, and the terminal agent unit 21 may transmit the first event control information to the test terminal (S14).

Accordingly, the terminal agent unit 21 of the test terminal may identify a component corresponding to the first component information on the screen based on the coordinates according to the first event control information, perform a function corresponding to the event type according to the first event control information for the identified component to cause an application (or a function of an application) corresponding to the identified component to be executed, and transmit another screen configuration information (hereinafter, 12-th screen configuration information) corresponding to an execution screen that is an execution result of the application (a function of the application) to the service providing apparatus 100 through the management terminal 20.

Further, the test performing unit 132 may generate event result information (first event result information) including the first test step and the 12-th screen configuration information received from the management terminal 20 as the execution result according to the execution of the first test step when receiving the 12-th screen configuration information, and match the generated event result information with the scenario identification information, and store the matching information in the test DB (S15).

Further, the test performing unit 132 may identify second component information corresponding to the second event information based on second event information corresponding to a second test step corresponding to a subsequent order of the first test step according to the test scenario information, identify coordinates corresponding to the second component information from the 12-th screen configuration information, generate second event control information including coordinates corresponding to the second component information and an event type according to the second event information, and transmit the second event control information to the test terminal through the management terminal 20 (S16, S17, and S19).

Accordingly, the mobile agent unit 31 of the test terminal may identify a component corresponding to the second component information based on the coordinates according to the second event control information, perform a function corresponding to the event type according to the first event control information for the identified component to cause an application (or a function of an application) corresponding to the identified component to be executed, and transmit yet another screen configuration information (hereinafter, 13-th screen configuration information) corresponding to an execution screen that is an execution result of the application (a function of the application) to the service providing apparatus 100 through the management terminal 20.

Further, the test performing unit 132 may generate event result information (first event result information) including the second test step and the 13-th screen configuration information as the execution result according to the execution of the second test step when receiving the 13-th screen configuration information, and match the generated event result information with the scenario identification information, and store the matching information in the test DB.

In this way, the test performing unit 132 may perform the test as described above for each of the remaining test steps included in the test scenario information.

Further, when the event result information is generated, the service providing apparatus 100 may check component information in event information corresponding to another test step corresponding to a next order of the test step included in the event result information based on the test scenario information, and check the screen configuration information in the event result Information.

Further, the test performing unit 132 may determine whether the component information of the other test step exists in the screen configuration information included in the event result information (S16), and determine whether the failure occurs in the event result information according to whether the component information in the other test step exists in the screen configuration information corresponding to the event result information (S17).

That is, when component information included in the event information corresponding to a specific test step according to the test scenario information is not present in the screen configuration information included in the event result information corresponding to the test step immediately before the specific test step, the test performing unit 132 may determine that a failure occurs, and generate failure occurrence information for the immediately preceding test step (S18).

In other words, when the screen configuration information corresponding to the test step immediately before the specific test step does not include information on the component that is an execution target of an input event corresponding to the specific test step, the test performing unit 132 may not perform the specific test step because a component that is a selection target of the specific test step is not present on the screen, so that it may be determined that the failure occurs.

As an example of this, the test performing unit 132 may identify second component information corresponding to the second event information based on the second event information corresponding to the first test step when performing the second test step corresponding to the next order of the first test step according to the test scenario information, check whether the second component information is present in the 12-th screen configuration information received from the management terminal 20 as an execution result according to the execution of the first test step, determine that the failure occurs when the second component information does is not present in the 12-th screen configuration information, and generate failure occurrence information including the first event result information including the 12-th screen configuration information.

In addition, the test performing unit 132 may complete all test steps according to the test scenario information (S19), and generate test result information based including event result information for each test step stored in the test DB, and match the generated test result information with the scenario identification information, and store the matching information in the test DB (S20).

In addition, when the failure occurs during the test process according to the test scenario information, the test performing unit 132 may generate test result information including the failure occurrence information, match the test result information with the scenario identification information, and store the test result information in the test DB.

In this case, the test performing unit 132 may extract terminal identification information of the test terminal corresponding to the event result information from the terminal DB when determining that the failure occurs, and include the terminal identification information in the failure occurrence information.

Meanwhile, the test performing unit 132 may sequentially automatically transmit event control information for each of one or more test steps according to the test scenario information to perform a test, check a response time for each test step according to a reception time of each of the one or more different screen configuration information, apply the response time for each of the test steps to a preset quality measurement criterion to measure a quality, and generate quality information on the measured quality and include the quality information in the test result information.

In addition, the test performing unit 132 may transmit (deliver) video request information for requesting a video related to a specific test step corresponding to the failure occurrence information to the test terminal through the management terminal 20 when generating the failure occurrence information.

In addition, the test performing unit 132 may receive recording information transmitted by the test terminal in response to the video request information through the management terminal 20, match the recording information with the scenario identification information when receiving the recording information, store the matching information in the test DB, and include the recording information in the test result information.

In addition, the test performing unit 132 may transmit notification information for notifying a failure occurrence (abnormality occurrence) to the user terminal 10 or a preset contact when generating the test result information including the failure occurrence information, and may transmit the notification information including link information connectable to the test result information in which the failure occurrence information is included.

In this way, the test performing unit 132 may provide a user or a manager who manages the application test according to the test scenario information to be able to confirm a failure occurrence state through a video according to the recording information while notifying the failure occurrence.

Alternatively, based on the quality information included in the test result information, the test performing unit 132 may determine that a delay occurs or an error occurs in an execution process of an application when a preset quality criterion is not satisfied, and transmit the video request information to the test terminal, and may generate the notification information corresponding to the test result information that does not satisfy the quality criterion, and transmit the notification information to the user terminal 10 or a preset contact.

Further, when the generation of the test result information corresponding to the test terminal is completed, the test performing unit 132 may automatically designate (select) another mobile terminal 30 connected to the management terminal 20 as a test target according to preset schedule information or the test request information, or automatically designate a mobile terminal 30 connected with another management terminal 20 communicating with the service providing apparatus 100 as a test target, generate the test result information for the designated mobile terminal 30 as the test target as described above, and store the test result information in the test DB, and generate the test result information for each of a plurality of different mobile terminals 30 capable of communicating through one or more management terminals 20 and store the test result information in the test DB.

Meanwhile, the dashboard management unit 133 may analyze one or more test result information stored in the test DB to generate analysis result information of a dashboard display scheme, and provide (transmit) the analysis result information to the user terminal 10 or a preset contact.

The user terminal 10, the management terminal 20, the mobile terminal 30, and the service providing apparatus 100 described above may be implemented by hardware components, software components, and/or combinations of the hardware components and the software components.

Further, the components described in the embodiments may be implemented by using one or more universal computers or special-purpose computers like any other devices a processor, controller, an arithmetic logic unit (ALU), a digital signal processor, a microcomputer, a field programmable gate array (FPGA), a programmable logic unit (PLU), a microprocessor, or any other device capable of executing and responding to an instruction.

The user terminal 10, the management terminal 20, the mobile terminal 30, and the service providing apparatus 100 may execute an operating system (OS) and one or more software applications performed on the operating system.

The service providing method according to the embodiment of the present disclosure described in the foregoing embodiment can be written as a computer program, and codes and code segments constituting the computer program can be easily inferred by a computer programmer in the art. In addition, the computer program is stored in a computer readable medium, and is read and executed by a computer, the user terminal 10, the management terminal 20, the mobile terminal 30, the service providing apparatus 100, and the like according to the embodiments of the present disclosure, thereby implementing the service providing method according to the embodiments.

The information storage medium includes a magnetic recording medium and an optical recording medium. The computer program implementing the service providing method according to the embodiments of the present disclosure may be stored and installed in the user terminal 10, the management terminal 20, the mobile terminal 30, and the internal memory of the service providing apparatus 100. Alternatively, an external memory such as a smart card in which a computer program implementing the service providing method according to the embodiment of the present disclosure is stored and installed may be mounted on the user terminal 10, the management terminal 20, the mobile terminal 30, and the service providing apparatus 100 through an interface.

Various apparatuses and components described in the present specification may be embodied by a hardware circuit (for example, a CMOS based logic circuit), firmware, software, or combinations thereof. For example, the apparatuses and components may be embodied by using a transistor, a logic gate, and an electronic circuit in the forms of various electric structures.

The aforementioned contents can be corrected and modified by those skilled in the art without departing from the essential characteristics of the present disclosure. Therefore, the exemplary embodiments of the present disclosure are provided for illustrative purposes only but not intended to limit the technical concept of the present disclosure. The scope of the technical concept of the present disclosure is not limited thereto. The protection scope of the present disclosure should be construed based on the following appended claims and it should be appreciated that the technical spirit included within the scope equivalent to the claims belongs to the scope of the present disclosure.

### EXPLANATION OF REFERENCE NUMERALS

10: User terminal
20: Management terminal
21: Terminal agent unit
30: Mobile terminal
31: Mobile agent unit
100: Service providing apparatus
110: Communication unit
120: Storage unit
130: Control unit
131: Scenario creation unit
132: Test performing unit
133: Dashboard management unit

What is claimed is:

1. A system for providing a service for testing an application, the system comprising:
a mobile agent unit configured in a mobile terminal, and configured to transmit a screen display image for a screen of the mobile terminal, obtain and provide screen configuration information used in an operating system of the mobile terminal for the screen display, and including coordinates for each operable component of the screen and component information, and perform a function according to remote control information upon receiving the remote control information for operating the mobile terminal;
a terminal agent unit configured in a management terminal communicating with the mobile terminal to receive the screen display image and transmit the screen display image in a streaming scheme, receive and transmit the screen configuration information corresponding to the screen display image, and receive and transmit the remote control information to the mobile terminal; and
a service providing apparatus configured to provide a web page for creating a test scenario of an application installed in the mobile terminal, provide the screen display image received from the terminal agent unit through the web page, generate the remote control information according to operation information on any one of one or more components included in the screen display image, transmit the remote control information to the terminal agent unit, extract the component information corresponding to the operation information from the screen configuration information, generate event information including the component information, and accumulate one or more event information generated until test scenario creation is completed to generate test scenario information.

2. The system of claim 1, wherein the event information includes a preset event type corresponding to an input event according to the operation information, and
the event type includes at least one of a touch, a click, a drag, a drop, a swipe, and a text input.

3. The system of claim 1, wherein the screen configuration information is XML-format information used for screen display in the operating system of the mobile terminal, and includes all kinds of component information displayed on the screen.

4. The system of claim 1, wherein the service providing apparatus sets a test step for each event information according to a generation order of the event information, and generates and stores test scenario information including event information for each of one or more test steps in a script form.

5. The system of claim 4, wherein the service providing apparatus is configured to select another mobile terminal in communication with the management terminal as a test terminal for testing according to the test scenario information, perform testing for the test terminal based on event information corresponding to a test step included in the test scenario information, identify component information according to the event information included in test scene information from screen configuration information received from the test terminal, extract coordinates corresponding to the identified component information from the screen configuration information, generate event control information for performing a function according to the event information on a component corresponding to the identified components information based on the extracted coordinates and the event information, and then transmit the event control information to the terminal agent unit 21 of the management terminal 20 so that the event control information is transmitted to the test terminal; receive screen configuration information for an execution screen switched by an application executed by the test terminal by performing the function according to the event control information as a response to the event control information from the management terminal 20, and then perform testing for each test step to generate event result information including the screen configuration information for the execution screen and the test step corresponding to the event control information, and generate test result information including the event result information for each test step at the time of termination of testing for all test steps.

6. The system of claim 5, wherein when component information included in the event information corresponding to a specific test step according to the test scenario information is not present in the screen configuration information included in the event result information corresponding to the test step immediately before the specific test step, the test performing unit determines that a failure occurs, generates failure occurrence information for the immediately preceding test step, and generates test result information including the failure occurrence information.

7. The system of claim 6, wherein the mobile agent unit is configured to record a screen of the mobile terminal from start to end of a test according to the test scenario information, generate recording information including a video, and store the recording information,
the service providing apparatus is configured to transmit video request information for the video request to the terminal agent unit when the failure occurrence information is generated, and
the terminal agent unit is configured to transmit the video request information to the mobile agent unit when receiving the video request information, and transmit the recording information received from the mobile agent unit to the service providing apparatus so as to be included in the test result information.

8. A method for providing a service for testing an application of a service providing apparatus, the method comprising:
obtaining a screen display image and screen configuration information for a screen of a mobile terminal transmitted by the mobile terminal;
providing a web page including the screen display image for creating a test scenario of an application installed in the mobile terminal, and receiving operation information on any one of one or more components included in the screen display image;
generating and transmitting remote control information according to the operation information so as to be transmitted to the mobile terminal, extracting component information corresponding to the operation information from the screen configuration information used in an operating system of the mobile terminal for displaying a screen corresponding to the screen display image, and including coordinates for each operable component of the screen and component information, and generating event information including the extracted component information; and
generating test scenario information by accumulating one or more event information generated until test scenario creation is completed.

9. An apparatus for providing a service for testing an application, the apparatus comprising:
a communication unit configured to communicate via a communication network; and
a control unit configured to obtain a screen display image and screen configuration information for a screen of a mobile terminal transmitted by the mobile terminal through the communication unit, provide a web page including the screen display image for creating a test scenario of an application installed in the mobile terminal, receive, through the communication unit, operation information for any one of one or more components included in the screen display image, generate remote control information according to the operation information and transmit the remote control information to the mobile terminal to be transmitted to the mobile terminal, extract component information corresponding to the operation information from the screen configuration information used in an operating system of the mobile terminal for displaying a screen corresponding to the screen display image, and including coordinates and component information for each operable component of the screen, generate event information including the component information, and accumulate one or more event information generated until completion of creating the test scenario to generate test scenario information.
